(19) United States
(12) Patent Application Publication
(10) Pub. No.: US 2020/0209278 A1
(43) Pub. Date: Jul. 2, 2020

(54) CHARGE OUTPUT ELEMENT, ASSEMBLY METHOD, AND PIEZOELECTRIC ACCELEROMETER

(71) Applicant: FATRI UNITED TESTING & CONTROL (QUANZHOU) TECHNOLOGIES CO., LTD., Fujian (CN)

(72) Inventors: Yongzhong NIE, Xiamen City, Fujian (CN); Chuan NIE, Xiamen City, Fujian (CN)

(73) Assignee: FATRI UNITED TESTING & CONTROL (QUANZHOU) TECHNOLOGIES CO., LTD., Fujian (CN)

(21) Appl. No.: 16/614,881

(22) PCT Filed: May 17, 2018
(86) PCT No.: PCT/CN2018/087293

§ 371 Date: Nov. 19, 2019

(30) Foreign Application Priority Data
Jun. 9, 2017 (CN) 201710433508.4

(51) Int. Cl. G01P 15/09; G01P 15/08

(52) U.S. Cl. CPC G01P 15/09; G01P 15/0802

(57) ABSTRACT

Disclosed is a charge output element, comprising: a support comprising a connecting part; a piezoelectric element, which is an annular structural body and is sleeved on the connecting part, wherein the piezoelectric element is provided with a first deformation groove, and the first deformation groove passes through a side wall of the piezoelectric element to disconnect the piezoelectric element in a circumferential direction; and a mass block, which is an annular structural body and is sleeved on the piezoelectric element, wherein the piezoelectric element is in interference fit with the connecting part and the mass block, and the piezoelectric element, the mass block and the support of the charge output element are in rigid contact with each other. Further disclosed are a method for assembling the charge output element and a piezoelectric accelerometer.

### CROSS-REFERENCE TO RELATED APPLICATION

The application is a National Stage of International Application No. PCT/CN2018/087293 filed on May 17, 2018, which claims priority to Chinese Patent Application No. 201710433508.4 filed on Jun. 9, 2017 and entitled “CHARGE OUTPUT ELEMENT, ASSEMBLY METHOD, AND PIEZOELECTRIC ACCELEROMETER”, both of which are incorporated herein by reference in their entireties.

### TECHNICAL FIELD

The disclosure relates to the technical field of sensor, and in particular to a charge output element, an assembly method, and a piezoelectric accelerometer.

### BACKGROUND

A piezoelectric accelerometer, known as piezoelectric acceleration sensor, belongs to an inertial sensor. The piezoelectric accelerometer is a sensor in which the force applied to the piezoelectric element by the mass block will change by means of the piezoelectric effect of the piezoelectric element as the accelerometer vibrates. When the detected vibration frequency is much lower than the natural frequency of the accelerometer, the change in force is proportional to the detected acceleration.

The charge output element is disposed in the piezoelectric accelerometer. In the prior art, various parts of the charge output element are connected through connecting layers. The connection through the connecting layers enables various parts of the charge output element to be assembled and combined, but the connection through the connecting layers requires extremely high quality and strict assembly operation of the connecting layer. If the connecting layer contains impurities or is operated improperly during assembly, the connection strength between the parts of the charge output element is low, and the overall rigidity of the charge output element is insufficient, and as a result, the frequency response characteristics and resonance of the piezoelectric accelerometer are too low.

### SUMMARY

Embodiments of the disclosure provide a charge output element, an assembly method, and a piezoelectric accelerometer, which can ensure the rigidity of the charge output element, thereby improving the frequency response characteristics and resonance of the piezoelectric accelerometer.

An embodiment of the disclosure provides a charge output device including: a support including a connecting part; a piezoelectric element, which is an annular structural body and connected to the connecting part in a sleeved manner, wherein the piezoelectric element is provided with a first deformation groove, which penetrates a side wall of the piezoelectric element to disconnect the piezoelectric element in a circumferential direction thereof; a mass block, which is an annular structural body and connected to the piezoelectric element in a sleeved manner, wherein the piezoelectric element is in interference fit with the connecting part and the mass block.

The charge output element according to the embodiment of the disclosure includes the support, the piezoelectric element and the mass block, and the piezoelectric element is in interference fit with the mass block and the support without the connection through the connecting layers. That is to say, the piezoelectric element, the mass block and the support are in rigid contact with each other, so that the connection strength is high, the overall rigidity of the charge output element is effectively improved, thereby improving the frequency response characteristics and resonance of the piezoelectric accelerometer. Moreover, the first deformation groove provided on the piezoelectric element to disconnect the piezoelectric element in the circumferential direction causes the piezoelectric element to have a greater deformation amount, so as to facilitate the assembly of the mass block, the piezoelectric element and the support, thereby improving the assembly efficiency of the charge output element.

Another aspect of the disclosure provides an assembly method for the charge output element, including the steps of:
a. cooling the mass block to cause it to be deformed and contracted;
b. taking out the deformed and contracted mass block, sleeving the pre-tightening ring on the deformed and contracted mass block, and making the mass block be in interference fit with the pre-tightening ring after its deformation is restored;
c. cooling the piezoelectric element to cause it to be deformed and contracted;
d. taking out the deformed and contracted piezoelectric element, sleeving the combined pre-tightening ring and mass block on the deformed and contracted piezoelectric element, and making the piezoelectric element be in interference fit with the mass block after its deformation is restored;
e. cooling the support to cause it to be deformed and contracted; and
f. taking out the deformed and contracted support, sleeving the combined pre-tightening ring, mass block, and piezoelectric element on the connecting part of the deformed and contracted support, and making the connecting part be in interference fit with the piezoelectric element after its deformation is restored.

A still another aspect of the disclosure provides a piezoelectric accelerometer including: the above-mentioned charge output element; a base including a mounting surface; a connector electrically connected to the piezoelectric element of the charge output element; and a protective cover disposed around the charge output element and connected between the base and the connector, wherein the charge output element is disposed on the mounting surface of the base.

### BRIEF DESCRIPTION OF THE DRAWINGS

Features, advantages, and technical effects of the exemplary embodiments of the disclosure will be described below with reference to the drawings.

FIG. 1 is a perspective structural view of a charge output element according to an embodiment of the disclosure;

FIG. 2 is a schematic cross-sectional structural view of a charge output element according to an embodiment of the disclosure;

FIG. 3 is a schematic structural view of a support according to an embodiment of the disclosure;

FIG. 4 is a schematic structural view of a piezoelectric element according to an embodiment of the disclosure;

FIG. 5 is a cross-sectional structural view of a charge output element according to another embodiment of the disclosure;

FIG. 6 is a schematic structural view of a pre-tightening ring according to another embodiment of the disclosure;

FIG. 7 is a schematic structural view of a mass block according to another embodiment of the disclosure;

FIG. 8 is a schematic perspective structural view of a piezoelectric accelerometer according to an embodiment of the disclosure; and

FIG. 9 is a schematic cross-sectional structural view of a piezoelectric accelerometer according to an embodiment of the disclosure, wherein:

| | | | |
|---|---|---|---|
| 1 | charge output element; | 10 | support; |
| 11 | connecting part; | 12 | supporting part; |
| 13 | positioning protrusion; | 20 | piezoelectric element; |
| 21 | inner annular surface; | 22 | outer annular surface; |
| 23 | first deformation groove; | 24 | first groove section; |
| 30 | mass block; | 31 | inner annular surface; |
| 32 | outer annular surface; | 33 | second deformation groove; |
| 34 | second groove section; | 40 | pre-tightening ring; |
| 41 | inner annular surface; | 42 | outer annular surface; |
| 2 | base; | 201 | mounting surface; |
| 3 | protective cover; | 4 | connector; |
| 5 | circuit board; | 6 | shielding cover; |
| 601 | center hole. | | |

### DETAILED DESCRIPTION

Features and exemplary embodiments in various aspects of the disclosure are described in detail below. In the following detailed description, numerous specific details are set forth to provide comprehensive understanding of the disclosure. However, it will be apparent to the skilled in the art that the disclosure may be practiced without some of the specific details. The following description of the embodiments is merely to provide a better understanding of the disclosure. In the drawings and the following description, at least some of the known structures and techniques are not shown, to prevent unnecessary obscure of the disclosure. For clarity, the dimension of some of the structures may be enlarged. Furthermore, features, structures, or characteristics described hereinafter may be combined in any suitable manner in one or more embodiments.

The orientation terms appearing in the following description refer to the directions shown in the drawings, and are not intended to limit the specific structure of the embodiment of the disclosure. In the description of the disclosure, it should also be noted that, unless otherwise explicitly stated and defined, the terms “mount” or “connect” shall be understood broadly, for example, they may be fixed connection or detachable connection or integral connection; alternatively, they may be direct connection or indirect connection. The specific meaning of the above terms in the disclosure may be understood by the skilled in the art based on the specific situation.

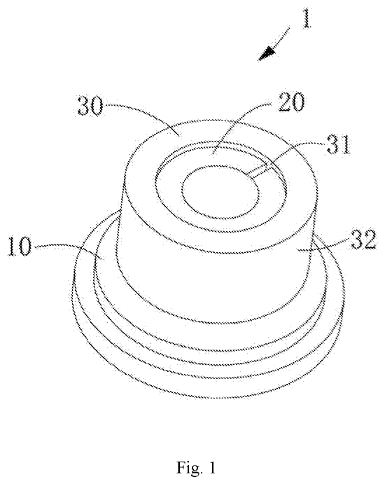

For a better understanding of the disclosure, a charge output element according to embodiments of the disclosure will be described in detail below with reference to FIG. 1 to FIG. 7.

As shown in FIG. 1 to FIG. 4, an embodiment of the disclosure provides a charge output element 1, including a support 10, a piezoelectric element 20, and a mass block 30. The support 10 includes a connecting part 11. The piezoelectric element 20 is an annular structural body, and the piezoelectric element 20 is connected to the connecting part 11 in a sleeved manner. The piezoelectric element 20 is provided with a first deformation groove 23, which penetrates a side wall of the piezoelectric element 20 to disconnect the piezoelectric element 20 in a circumferential direction thereof. The mass block 30 is an annular structural body, and the mass block 30 is connected to the piezoelectric element 20 in a sleeved manner. The piezoelectric element 20 is in interference fit with the connecting part 11 and the mass block 30.

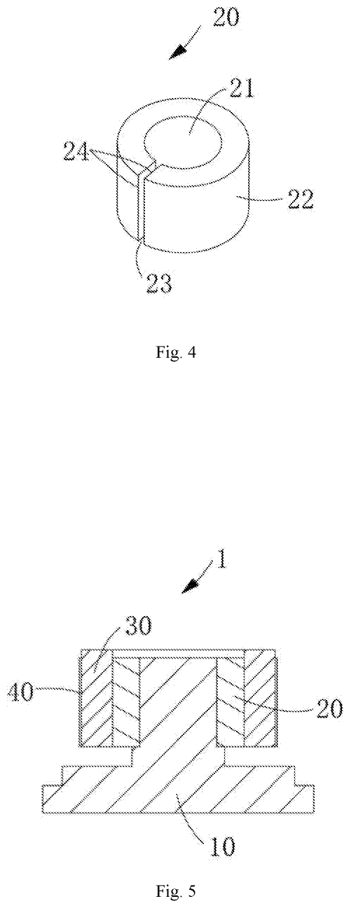

Specifically, as shown in FIG. 3, the support 10 is made of chrome. The support 10 includes the connecting part 11 having a circular columnar structure and being a solid body, and a supporting part 12 having a disk-like structure disposed around the connecting part 11 and located at one end of the connecting part 11. The outer wall surface of the connecting part 11 is provided with a positioning protrusion 13 along a circumferential direction thereof, and the positioning protrusion 13 has a height higher than a height of the supporting part 12. As shown in FIG. 4, the piezoelectric element 20 is made of a piezoelectric ceramic, and the piezoelectric element 20 is an annular structural body including an inner annular face 21 and an outer annular face 22 that are opposite. Each of the inner annular face 21 and the outer annular face 22 is provided with a conductive layer, to facilitate the transmission of electrical signal of the piezoelectric element 20. The conductive layer may be a gold plating layer. The inner annular surface 21 of the piezoelectric element 20 is connected to the connecting part 11 in a sleeved manner and the lower end thereof abuts against the positioning protrusion 13. The positioning protrusion 13 facilitates the positioning support of the piezoelectric element 20. The inner annular surface 21 of the piezoelectric element 20 has a diameter smaller than a diameter of the connecting part 11. The first deformation groove 23 is a strip groove and extends along an axial direction of the piezoelectric element 20. Two opposing first groove sections 24 are formed at the first deformation groove 23 of the piezoelectric element 20, and the distance between the two opposing first groove sections 24 is 0.2 mm, which facilitates processing and assembly while ensuring that the piezoelectric element 20 has a larger deformation amount.

The mass block 30 is made of a tungsten alloy, and is an annular structural body including an inner annular surface 31 and an outer annular surface 32 that are opposite. The inner annular surface 31 of the mass block 30 is connected to the outer annular surface 22 of the piezoelectric element 20 in a sleeved manner, and is located and suspended above the supporting part 12. The inner annular surface 31 of the mass block 30 has a diameter smaller than the diameter of the outer annular surface 22 of the piezoelectric element 20, so that the piezoelectric element 20 is in interference fit with the connecting part 11 and the mass block 30.

In the charge output element 1 according to the embodiment of the disclosure, the piezoelectric element 20 is in interference fit with the connecting part 11 and the mass block 30 without the connection via the connecting layers. That is to say, the piezoelectric element 20, the mass block 30 and the support 10 are in rigid contact with each other, so that the connection strength is high, the overall rigidity of the charge output element 1 is effectively improved, thereby improving the frequency response characteristics and resonance of the piezoelectric accelerometer. Moreover, the first deformation groove 23 provided on the piezoelectric element 20 to disconnect the piezoelectric element 20 in the circumferential direction causes the piezoelectric element 20 to have a greater deformation amount so as to facilitate the assembly of the mass block 30, the piezoelectric element 20 and the support 10, thereby improving the assembly efficiency of the charge output element 1. The first deformation groove 23 implemented as the strip groove and extending along the axial direction of the piezoelectric element 20 facilitates the processing and can reduce the influence on the overall performance of the charge output element 1 when the piezoelectric element 20 is deformed.

It is to be understood that the first deformation groove 23 is not limited to the strip groove. In some alternative embodiments, the first deformation groove 23 may be a toothed groove or an irregular groove. The first deformation groove 23 is not limited to extending along the axial direction of the piezoelectric element 20, and may intersect the axis of the piezoelectric element 20, as long as the first deformation groove 23 is ensured to penetrate the side wall of the piezoelectric element 20 to enable the piezoelectric element 20 to be disconnected in the circumferential direction so that the piezoelectric element 20 has a larger deformation amount. The distance between the two opposing first groove sections 24 is not limited to 0.2 mm, and in some alternative embodiments, may be less than 0.2 mm, preferably 0.1 mm, so as to better ensure the performance of the charge output element 1 while ensuring the requirement of the deformation amount of the piezoelectric element 20. The piezoelectric element 20 is not limited to being made of the piezoelectric ceramic, and in some embodiments, a single crystal such as a quartz crystal may also be possible. Moreover, the piezoelectric element 20 and the mass block 30 are not limited to the annular structural body. In some alternative embodiments, a polygonal annular structural body may also be possible. Correspondingly, the connecting part 11 may be a polygonal columnar structural body, as long as it can satisfy the use requirements of the charge output element 1.

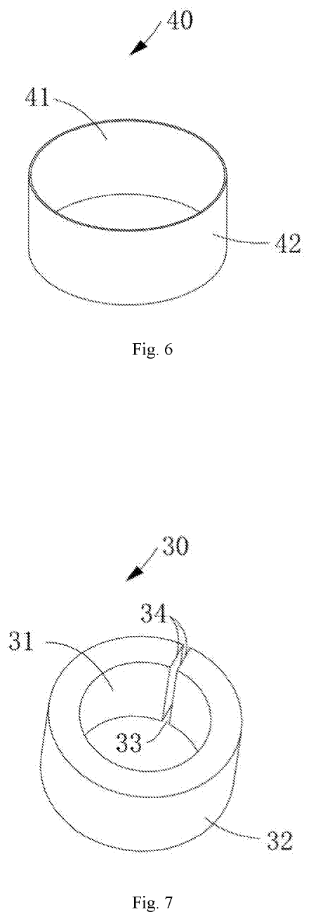

As an alternative implementation, as shown in FIG. 5 and FIG. 6, the charge output element 1 further includes a pre-tightening ring 40. The pre-tightening ring 40 is made of a titanium alloy and is an annular structural body including an inner annular surface 41 and an outer annular surface 42 that are opposite. Correspondingly to the provision of the pre-tightening ring 40, as shown in FIG. 7, the mass block 30 is further provided with a second deformation groove 33, and the second deformation groove 33 penetrates the side wall of the mass block 30 to disconnect the mass block 30 in the circumferential direction thereof. The second deformation groove 33 is a strip groove and extends along the axial direction of the mass block 30, and two opposing second groove sections 34 are formed at the second deformation groove 33 of the mass block 30. The distance between the two opposing second groove cuts 34 is 0.2 mm, which facilitates processing and assembly while ensuring that the mass block 30 has a larger deformation amount. The pre-tightening ring 40 is connected to the mass block 30 in a sleeved manner. The inner annular surface 41 of the pre-tightening ring 40 has a diameter smaller than a diameter of the outer annular surface 32 of the mass block 30 to allow the pre-tightening ring 40 to be in interference fit with the mass block 30.

By providing the pre-tightening ring 40 and correspondingly providing the second deformation groove 33 on the mass block 30, a certain pre-tightening force can be applied to the mass block 30, so as to facilitate assembly of the support 10, the piezoelectric element 20 and the mass block 30, to improve the connection strength among the support 10, the piezoelectric element 20 and the mass block 30, and to improve the overall rigidity of the charge output element 1, thereby ensuring the frequency response characteristic of the piezoelectric accelerometer. The second deformation groove 33 implemented as the strip groove and extending along the axial direction of the mass block 30 facilitates processing and can reduce the influence on the overall performance of the charge output element 1 when the mass block 30 is deformed.

It is to be understood that the second deformation groove 33 is not limited to the strip groove. In some alternative embodiments, the second deformation groove 33 may be a toothed groove or an irregular groove. Moreover, the second deformation groove 33 is not limited to extending along the axial direction of the mass block 30, and may also intersect the axis of the mass block 30, as long as the second deformation groove 33 is ensured to penetrate the side wall of the mass block 30 to enable the mass block 30 to be disconnected in the circumferential direction so that the mass block 30 has a larger deformation amount. The distance between the two opposing second groove sections 34 is not limited to 0.2 mm, and in some alternative embodiments, may be less than 0.2 mm, preferably 0.1 mm, so as to better ensure the performance of the charge output element 1 while ensuring the requirement of the deformation amount of the mass block 30. The pre-tightening ring 40 is not limited to the annular structural body, and correspondingly to the structure of the mass block 30, a polygonal annular structural body may be possible.

Since the pre-tightening ring 40, the mass block 30, the piezoelectric element 20, and the support 10 of the charge output element 1 according to the present embodiment are made of different materials, they have different linear expansion coefficients, and since the pre-tightening ring 40, the mass block 30, the piezoelectric element 20 and the support 10 are in interference fit with each other, that is, are in rigid contact with each other, the fluctuation of the stress of the charge output element 1 can be reduced when the charge output element 1 is applied in a high temperature environment, so that the charge output element 1 has high temperature characteristics. In one embodiment, the linear expansion coefficients of the pre-tightening ring 40, the mass block 30, the piezoelectric element 20, and the support 10 are preferably sequentially decreased so that the assembly efficiency of the charge output element 1 can be further improved while better high temperature characteristics of the charge output element 1 is ensured.

Another embodiment of the disclosure further provides an assembly method of the charge output element 1 for assembling the charge output element 1 according to the above embodiments. The specific operation steps are as follows:
a. placing the mass block 30 in a cooling liquid so that the mass block 30 is cooled to be deformed and contracted;
b. taking out the deformed and contracted mass block 30, sleeving the pre-tightening ring 40 on the deformed and contracted mass block 30 (since the mass block 30 is deformed and contracted, its size is correspondingly reduced, and at this time, the pre-tightening ring 40 is in clearance fit with the mass block 30 for assembly), and placing the mass block 30 and the pre-tightening ring 40 in a normal temperature environment so that the mass block 30 is in interference fit with the pre-tightening ring 40 after its deformation is restored;
c. placing the piezoelectric element 20 in the cooling liquid so that the piezoelectric element 20 is cooled to be deformed and contracted;
d. taking out the deformed and contracted piezoelectric element 20, sleeving the combined pre-tightening ring 40 and the mass block 30 on the deformed and contracted piezoelectric element 20 (since the piezoelectric element 20 is deformed and contracted, its size is correspondingly reduced, and at this time, the mass block 30 is in clearance fit with the piezoelectric element 20 for assembly), and placing the pre-tightening ring 40, the mass block 30, and the piezoelectric element 20 in the normal temperature environment so that the piezoelectric element 20 is in interference fit with the mass block 30 after its deformation is restored;
e. placing the support 10 in the cooling liquid so that the support 10 is cooled to be deformed and contracted;
f. taking out the deformed and contracted support 10, and sleeving the combined pre-tightening ring 40, the mass block 30 and the piezoelectric element 20 on the connecting part 11 of the deformed and contracted support 10 (since the support 10 is deformed and contracted, its size is correspondingly reduced, and at this time, the connecting part 11 of the support 10 is in clearance fit with the piezoelectric element 20), and placing the pre-tightening ring 40, the mass block 30, the piezoelectric element 20, and the support 10 in the normal temperature environment so that the connecting part 11 is in interference fit with the piezoelectric element 20 after its deformation is restored. As such, the assembly of the charge output element 1 is completed.

The assembly method of the charge output element 1 according to the present embodiment of the disclosure assembles the pre-tightening ring 40, the mass block 30, the piezoelectric element 20 and the support 10 of the charge output element 1 together by a cold-packing process, and the assembly of the charge output element 1 can be completed without other connecting layers. The assembly method according to the disclosure is more efficient and has a shorter installation cycle than the assembly method via the connecting layers in the prior art. Moreover, since the interference fit is used among the pre-tightening ring 40, the mass block 30, the piezoelectric element 20 and the support 10, the overall rigidity of the charge output element 1 can be improved, thereby improving the frequency response characteristics and resonance of the piezoelectric accelerometer.

It is to be understood that the cooling of the mass block 30, the piezoelectric element 20 and the support 10 in the above embodiment is not limited to the cooling by means of the cooling liquid. In some alternative embodiments, the mass block 30, the piezoelectric element 20, and the support 10 may be cooled by using dry ice, refrigeration equipment, or the like as required. Moreover, the mass block 30, the piezoelectric element 20 and the support 10 which are cooled to be deformed and contracted are not limited to being placed in the normal temperature environment to cause their deformation to be restored. In some embodiments, they may be placed in the environment whose temperature is higher than the temperature of the cooling liquid or in other temperature environments, as long as the deformation of the respective cooled mass block 30, the piezoelectric element 20, and the support 10 can be restored.

As an alternative implementation, in the steps a, c, and e, the cooling temperature for the mass block 30, the piezoelectric element 20 and the support 10 is calculated from the maximum interference amount during the fitting, the fitting diameter, and the linear expansion coefficient of the material by using the specific calculation formula (1):

$$T = \frac{2 σ}{ɛ d} \qquad ( 1 )$$

In formula (1), T represents the cooling temperature; σ represents the maximum interference amount during the fitting; it is to be understood in the present embodiment that the maximum interference amount during the fitting represents accordingly the maximum interference amount when the pre-tightening ring 40 is in fit with the mass block 30, the maximum interference amount when the mass block 30 is in fit with the piezoelectric element 20, or the maximum interference amount when the piezoelectric element 20 is in fit with the connecting part 11 of the support 10; ϵ represents the linear expansion coefficient of the material, namely, the linear expansion coefficient of the material corresponding to the member to be cooled, and it is to be understood in the present embodiment that the member to be cooled corresponds to the mass block 30, the piezoelectric element 20 or the support 10; and d represents the fitting diameter, namely, the outer diameter of the contained member, and it is to be understood in the present embodiment that the contained member corresponds to the mass block 30, the piezoelectric element 20 or the support 10. In the specific implementation, σ and d can be calculated according to the dimensions of the pre-tightening ring 40, the mass block 30, the piezoelectric element 20 and the support 10 of the charge output element 1, and ϵ can be obtained by looking up the table.

In the steps a, c, and e, the cooling time for the mass block 30, the piezoelectric element 20, and the support 10 is calculated from the comprehensive coefficient and the maximum wall thickness of each of the mass block 30, the piezoelectric element 20, and the support 10 by using the specific calculation formula (2):

t=αδ+6 (2)

In the formula (2), δ represents the maximum wall thickness, namely, the maximum wall thickness of the member to be cooled, it is to be understood in the present embodiment that the member to be cooled corresponds to the mass block 30, the piezoelectric element 20 or the support 10 (since the connecting part 11 of the support 10 has a solid structure, the maximum wall thickness of the connecting part 11 is a radius of its section); α represents a comprehensive coefficient, namely, a comprehensive coefficient related to the material of the member to be cooled, which can be obtained by looking up the table, and it is to be understood in the present embodiment that the member to be cooled corresponds to the mass block 30, the piezoelectric element 20 or the support 10.

The freezing temperature and the freezing time for the mass block 30, the piezoelectric element 20 or the support 10 of the charge output element 1, which is calculated by the above manner, can configure the cooling manner and the corresponding cooling time point more reasonably, thereby improving the assembly efficiency of the charge output element 1.

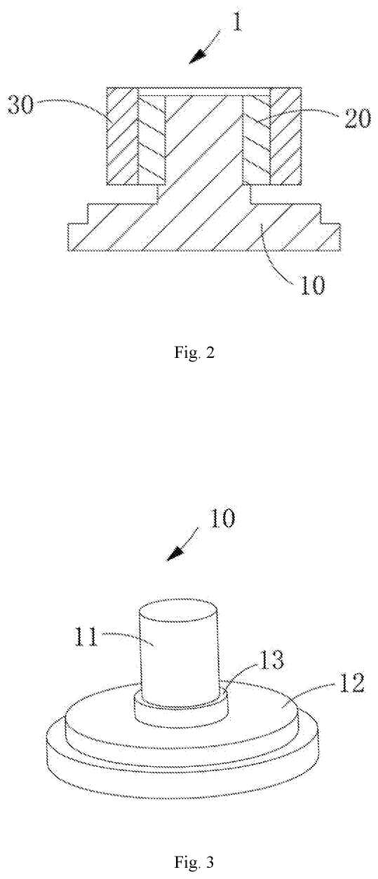

The assembly method according to the present embodiment is to assemble the charge output element 1 (which includes the pre-tightening ring 40 and the second deformation groove 33 provided on the mass block 30) according to the embodiment shown in FIG. 5. The assembly method for the charging output element 1 according to the embodiment shown in FIG. 1 and FIG. 2 (which includes no pre-tightening ring 40 and no second deformation groove 33 provided on the mass block 30) is the same as the above-mentioned assembly method, but the steps a and b for cooling the mass block 30 and for assembling the pre-tightening ring 40 and the mass block 30 are omitted.

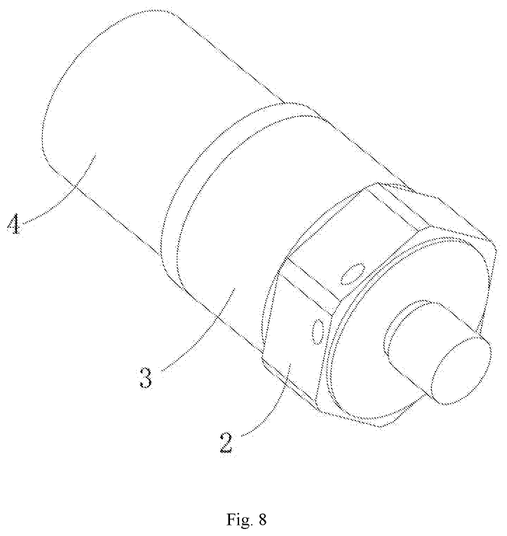

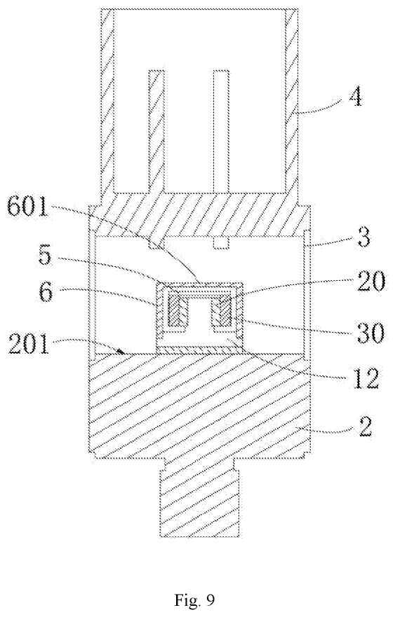

As shown in FIG. 8 and FIG. 9, a further embodiment of the disclosure further provides a piezoelectric accelerometer including a base 2, a protective cover 3, a connector 4, and the charge output element 1 according to any of the above embodiments. The base 2 has a mounting surface 201, and the supporting part 12 of the charge output element 1 is fixedly disposed on the mounting surface 201 of the base 2. The protective cover 3 is a circular sleeve structural body and is disposed around the charge output element 1. The protective cover 3 is connected between the base 2 and the connector 4. Specially, one end of the protective cover 3 is fixedly coupled to the base 2, and the other end is fixedly coupled to the connector 4. The connector 4 is electrically connected to the piezoelectric element 20 of the charge output element 1. In use, the base 2 is connected to the device to be tested, the vibration of the device to be tested is transmitted to the charge output element 1 through the base 2, and the charge output element 1 converts the vibration of the device to be tested and transmits signals to the external device through the connector 4, so as to complete the detection of the device to be tested.

In the piezoelectric accelerometer according to the embodiment of the disclosure, since the charge output element 1 with high overall rigidity is used, the frequency response characteristics and resonance of the piezoelectric accelerometer can be effectively improved, the high temperature characteristic is good, and the accuracy of the detection result can be ensured.

As an alternative implementation, the piezoelectric accelerometer further includes a circuit board 5, and the circuit board 5 is fixed on the mass block 30. At this time, the piezoelectric element 20 and the connector 4 are electrically connected to the circuit board 5. The circuit board 5 can process a weak electrical signal generated by the piezoelectric element 20 due to the force, so that the piezoelectric accelerometer constitutes a voltage output type piezoelectric accelerometer to meet the use requirements. Moreover, a shielding cover 6 is snap-fitted on the support 10. The shielding cover 6 is a cylindrical structural body with an open end. The open end of the shielding cover 6 is snap-fitted to the support 10 and specifically is engaged with the supporting part 12 of the support 10. The piezoelectric element 20, the mass block 30 and the circuit board 5 are all located within the shielding cover 6. In the present embodiment, the outer annular surface 22 of the piezoelectric element 20 is electrically connected to one terminal of the circuit board 5 via the mass block 30, and the inner annular surface 21 of the piezoelectric element 20 is electrically connected to the other terminal of the circuit board 5 via the support 10 and the shielding cover 6. The two terminals have opposite polarities. A center hole 601 is provided on the top of the shielding cover 6 corresponding to the open end thereof, and one end of the wire drawn from the terminal of the circuit board 5 is passed through the center hole and electrically connected to the outer surface of the shielding cover 6. The provision of the shielding cover 6 can avoid external signal interference with the charge output element 1 and the circuit board 5, further ensure the accuracy of the detection result of the piezoelectric accelerometer, and facilitate the electrical connection of the piezoelectric element 20 with the circuit board 5.

Although the disclosure has been described with reference to the preferred embodiments, various modifications may be made thereto and the components may be replaced with equivalents without departing from the scope of the application. In particular, the technical features mentioned in the various embodiments can be combined in any manner as long as there is no structural conflict. The disclosure is not limited to the specific embodiments disclosed herein, but includes all technical solutions falling within the scope of the claims.

1. A charge output element, comprising:
a support, comprising a connecting part;
a piezoelectric element, which is an annular structural body and is connected to the connecting part in a sleeved manner, wherein the piezoelectric element is provided with a first deformation groove, which penetrates a side wall of the piezoelectric element to disconnect the piezoelectric element in a circumferential direction; and
a mass block, which is an annular structural body and is connected to the piezoelectric element in a sleeved manner,
wherein the piezoelectric element is in interference fit with the connecting part and the mass block.

2. The charge output element according to claim 1, wherein the mass block is provided with a second deformation groove penetrating a side wall of the mass block to disconnect the mass block in a circumferential direction thereof, and the charge output element further comprises a pre-tightening ring which is connected to the mass block in a sleeved manner and is in interference fit with the mass block.

3. The charge output element according to claim 2, wherein the first deformation groove is a strip groove and extends along an axial direction of the piezoelectric element, and the second deformation groove is a strip groove and extends along an axial direction of the mass block.

4. The charge output element according to claim 2, wherein the piezoelectric element comprises two opposing first groove sections formed at the first deformation groove and the distance between the two opposing first groove sections is not more than 0.2 mm, and the mass block comprises two opposing second groove sections formed on at the second deformation groove and the distance between the two opposing second groove sections is not more than 0.2 mm.

5. The charge output element according to claim 2, wherein linear expansion coefficients of the pre-tightening ring, the mass block, the piezoelectric element, and the support decrease sequentially.

6. The charge output element according to claim 2, wherein the piezoelectric element is made of a piezoelectric ceramic or a quartz crystal, and the piezoelectric element comprises opposing inner and outer annular surfaces, the inner annular surface and the outer annular surface are each provided with a conductive layer, the inner annular surface of the piezoelectric element is connected to the connecting part in a sleeved manner, and the mass block is connected to the outer annular surface of the piezoelectric element in a sleeved manner.

7. The charge output element according to claim 2, wherein the support further comprises a supporting part, the connecting part has a columnar structure, and the supporting part has a disk-like structure disposed around the connecting part and is located at one end of the connecting part.

8. An assembly method for the charge output element according to claim 2, comprising the steps of:
a. cooling the mass block to cause it to be deformed and contracted;
b. taking out the deformed and contracted mass block, sleeving the pre-tightening ring on the deformed and contracted mass block, and making the mass block be in interference fit with the pre-tightening ring after its deformation is restored;
c. cooling the piezoelectric element to cause it to be deformed and contracted;
d. taking out the deformed and contracted piezoelectric element, sleeving the combined pre-tightening ring and mass block on the deformed and contracted piezoelectric element, and making the piezoelectric element be in interference fit with the mass block after its deformation is restored;
e. cooling the support to cause it to be deformed and contracted; and
f. taking out the deformed and contracted support, sleeving the combined pre-tightening ring, mass block, and piezoelectric element on the connecting part of the deformed and contracted support, and making the connecting part be in interference fit with the piezoelectric element after its deformation is restored.

9. The assembly method for the charge output element according to claim 8, wherein a cooling temperature in steps a, c and e for the mass block, the piezoelectric element and the support is calculated from maximum interference amount during fitting, fitting diameter and linear expansion coefficient of material; and
a cooling time in steps a, c and e for the mass block, the piezoelectric element and the support is calculated from comprehensive coefficients and maximum wall thicknesses of each of the mass block, the piezoelectric element, and the support.

10. A piezoelectric accelerometer, comprising:
the charge output element according to claim 1;
a base, comprising a mounting surface;
a connector, which is electrically connected to the piezoelectric element of the charge output element; and
a protective cover, which is disposed around the charge output element and connected between the base and the connector,
wherein the charge output element is disposed on the mounting surface of the base.

11. The piezoelectric accelerometer according to claim 10, further comprising a circuit board fixed to the mass block, the piezoelectric element and the connector being electrically connected to the circuit board.

12. The piezoelectric accelerometer according to claim 11, further comprising a shielding cover, the shielding cover being snap-fitted to the support, the piezoelectric element, the mass block and the circuit board being located within the shielding cover.

13. The piezoelectric accelerometer according to claim 10, wherein the mass block is provided with a second deformation groove penetrating a side wall of the mass block to disconnect the mass block in a circumferential direction thereof, and the charge output element further comprises a pre-tightening ring which is connected to the mass block in a sleeved manner and is in interference fit with the mass block.

14. The piezoelectric accelerometer according to claim 13, wherein the first deformation groove is a strip groove and extends along an axial direction of the piezoelectric element, and the second deformation groove is a strip groove and extends along an axial direction of the mass block.

15. The piezoelectric accelerometer according to claim 13, wherein the piezoelectric element comprises two opposing first groove sections formed at the first deformation groove and the distance between the two opposing first groove sections is not more than 0.2 mm, and the mass block comprises two opposing second groove sections formed on at the second deformation groove and the distance between the two opposing second groove sections is not more than 0.2 mm.

16. The piezoelectric accelerometer according to claim 13, wherein linear expansion coefficients of the pre-tightening ring, the mass block, the piezoelectric element, and the support decrease sequentially.

17. The piezoelectric accelerometer according to claim 13, wherein the piezoelectric element is made of a piezoelectric ceramic or a quartz crystal, and the piezoelectric element comprises opposing inner and outer annular surfaces, the inner annular surface and the outer annular surface are each provided with a conductive layer, the inner annular surface of the piezoelectric element is connected to the connecting part in a sleeved manner, and the mass block is connected to the outer annular surface of the piezoelectric element in a sleeved manner.

18. The piezoelectric accelerometer according to claim 13, wherein the support further comprises a supporting part, the connecting part has a columnar structure, and the supporting part has a disk-like structure disposed around the connecting part and is located at one end of the connecting part.
